(19) United States
(12) Patent Application Publication
(10) Pub. No.: US 2019/0135253 A1
(43) Pub. Date: May 9, 2019

(54) BRAKE ACTUATOR WITH INTERNAL BREATHING VALVE

(71) Applicant: Indian Head Industries, Inc., Charlotte, NC (US)

(72) Inventors: Wayne Oster, Redwood Valley, CA (US); David Bruce Frankel, Charlotte, NC (US); Steve Lepard, Concord, NC (US)

(21) Appl. No.: 16/181,611

(22) Filed: Nov. 6, 2018

Related U.S. Application Data
(60) Provisional application No. 62/581,823, filed on Nov. 6, 2017.

(51) Int. Cl. B60T 13/26

(52) U.S. Cl. CPC B60T 13/261

(57) ABSTRACT

A spring brake actuator assembly for actuating a brake includes a spring chamber and a service chamber. A central flange defines opposing first and second cup-shaped sections. A spring chamber housing is interconnected to the first cup-shaped section of the central flange case for defining a spring chamber. A reciprocating piston is disposed in the spring chamber and includes a tubular push rod being biased into the service chamber from the spring chamber by a power spring disposed between the spring chamber housing and the reciprocating piston. The spring chamber is sealably bifurcated into a spring portion and a brake release portion. The brake release portion is subject to pneumatic pressure for compressing the power spring disposed in the spring chamber. A service flexible diaphragm defines the service chamber that is also subject to pneumatic pressure for driving a push rod outwardly of the service chamber to actuate a brake.

### PRIOR APPLICATIONS

The present application claims priority to U.S. Provisional Patent Application No. 62/581,823 filed on Nov. 6, 2017, the contents of which are included herein by reference.

### TECHNICAL FIELD

The present invention relates generally toward an improvement for spring brake actuators for use on heavy duty trucks. More specifically, the present invention relates toward an improved pneumatic arrangement for preventing access of environmental contamination to a power spring.

### BACKGROUND

Various spring brake actuators have been in use on heavy duty trucks for very many years. A spring brake actuator is used to actuate either drum or disc brakes, depending on a particular brake configuration. A spring brake actuator typically includes a spring chamber and a service chamber. The spring chamber and the service chamber are separated by a central flange defining opposing first and second cup-shaped sections. A spring chamber housing is interconnected to the first cup-shaped section for defining the spring chamber, and a service chamber housing is interconnected to the second cup-shaped section for defining the service chamber. A reciprocating piston is disposed in the spring chamber and includes a tubular push rod that is biased into the service chamber from the spring chamber by a power spring. The power spring is disposed between the spring chamber housing and the reciprocating piston.

A first flexible diaphragm bifurcates the spring chamber into a spring portion and a brake release portion, with the brake release portion being subject to pneumatic pressure. The pneumatic pressure is capable of compressing the power spring disposed in the spring chamber causing the tubular push rod to withdraw into the spring chamber. As is known to those of skill in the art, full extension of the tubular push rod results in full actuation of the brakes. A second flexible diaphragm defines the service chamber that is subject to pneumatic pressure for driving a push rod outwardly of the service chamber for actuating the brake.

The spring chamber is typically vented to the atmosphere so that compression of the power spring during application of pneumatic pressure to the brake release portion of the spring chamber is not resisted due to the shrinking volume in the spring portion of the spring chamber. Absent venting of the spring chamber, additional pressure would be required to fully compress the power spring upon application of pneumatic pressure to the brake release portion of the spring chamber.

Venting the spring chamber to the atmosphere requires an opening be disposed within the spring chamber housing. It is well known that environmental contaminants including road salt, dirt, grit, moisture, and other corrosive products degrade the functionality of the power spring. Further, corrosion of the power spring is accelerated duo to its highly stressed configuration when the power spring is compressed.

Various attempts have been made to internally vent the spring chamber, or interconnect to an external pneumatic system. These various attempts to prevent environmental contamination from entering the spring chamber have proven costly and inadequate. Therefore, it would be desirable to provide a simplified spring chamber venting system that is low cost and practical.

### SUMMARY

A spring brake actuator assembly for actuating a brake includes a spring chamber and a service chamber. A central flange defines opposing first and second cup-shaped sections. A spring chamber housing is interconnected to the first cup-shaped section of the central flange case for defining a spring chamber reciprocating piston is disposed in the spring chamber and includes a tubular push rod being biased into the service chamber from the spring chamber by a power spring disposed between the spring chamber housing and the reciprocating piston. The first flexible diaphragm sealably bifurcates the spring chamber into a spring portion and a brake release portion. The brake release portion is subject to pneumatic pressure for compressing the power spring disposed in the spring chamber. When the power spring is compressed, the tubular push rod is withdrawn into the spring chamber. A second flexible diaphragm defines the service chamber that is also subject to pneumatic pressure for driving a push rod outwardly of the service chamber to actuate a brake. The service chamber is fluidly connected with the spring chamber through the tibular push rod and is separable by a valve including a valve piston. The valve piston is biased within the valve to pneumatically connect the service chamber to the spring chamber. Therefore, the valve is open when the valve is disposed in one of the chambers that is subject to pneumatic pressure that is insufficient for overcoming the bias of the valve piston providing fluid communication between the spring chamber and the service chamber. When the valve is disposed in a chamber with sufficient pneumatic pressure to compress the valve spring, the valve closes sealing the service chamber from the piston chamber.

The simplified valve that makes use of a valve piston that is biased into an open disposition and into a closed position by pneumatic pressure upon pressurizing the service chamber solves a significant problem known to prior art actuator assemblies. The valve of the present invention allows the pressurized air to actuate the valve into a closed position when desirable to seal the spring chamber from the service chamber and bias of the valve piston to pneumatically connect the service chamber to the spring chamber when an internal transfer of pneumatic pressure is desirable service diaphragm

### BRIEF DESCRIPTION OF THE DRAWINGS

Other advantages of the present invention will be really appreciated as the same becomes better understood by reference to the following detailed description when considered in connection with the accompanied drawings, wherein:

FIG. 1 shows a spring brake actuator of the present invention with an extended power spring and the brake release chamber being depressurized;

FIG. 2 shows the spring brake actuator of the present invention having a brake release chamber pressurized for compressing the power spring;

FIG. 3 shows a close-up perspective view of the valve of the present application in its open disposition;

FIG. 4A shows the valve of the present invention in its biased or open position;

FIG. 4B shows the valve of the present invention in its closed position;

FIG. 5 shows a crossectional, perspective view of an alternative valve embodiment;

FIG. 6A shows the alternative valve of the present invention in its open position;

FIG. 68 shows the alternative valve of the present invention in its transitional position; and;

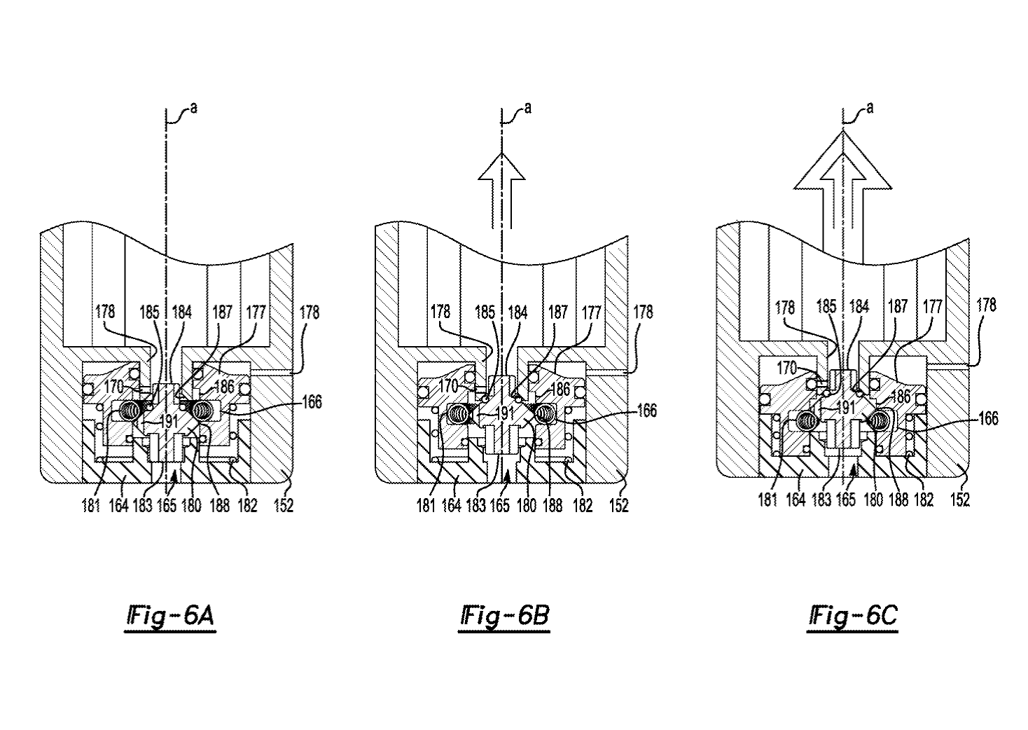

FIG. 6C shows the alternative valve of the present invention in its closed,

### DETAILED DESCRIPTION

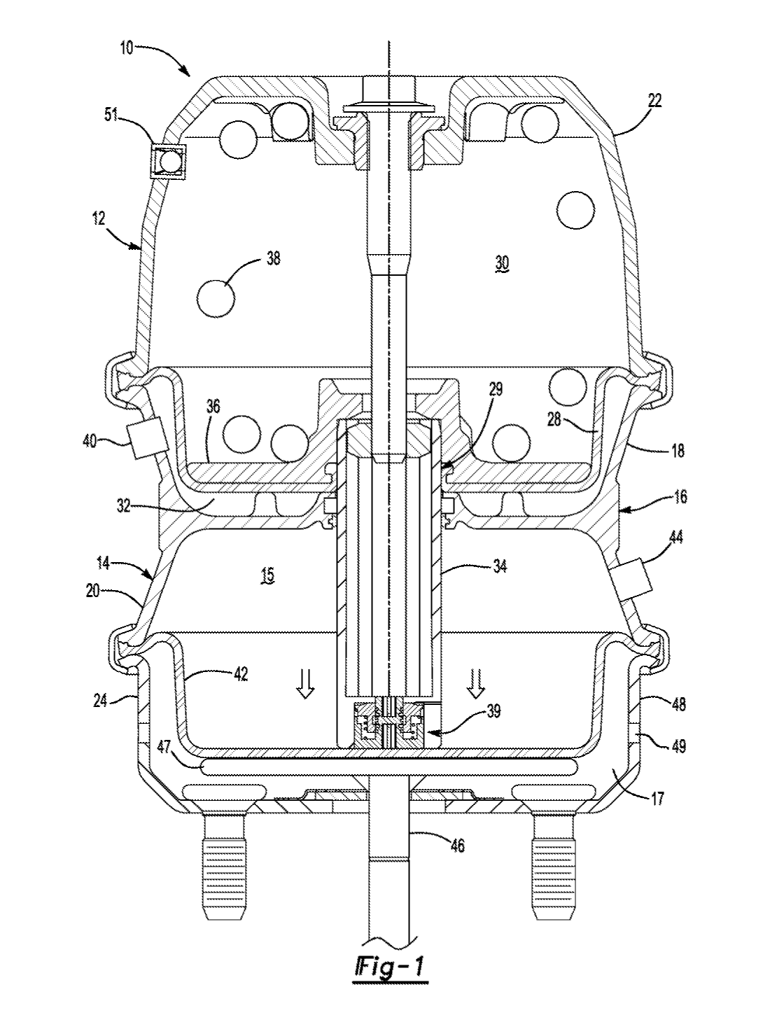

Referring to FIG. 1, a cross-sectional view of a spring brake actuator is generally shown at 10. The brake actuator 10 includes a spring chamber 12 and a service chamber 14. A central flange 16 defines a first cup-shaped section 18 and a second cup-shaped section 20. A spring chamber housing 22 is interconnected with the first cup-shaped section. 18 of the central flange 16 to define the spring chamber 12. A service chamber housing 24 is interconnected to the second cup-shaped section. 20 to define the service chamber 14.

A first flexible diaphragm 28 bifurcates the spring chamber 12 into a spring portion 30 and a brake release portion 32. The spring diaphragm 28 receives a tubular power spring pushrod 34 through a central opening 29 to sealably engage the spring diaphragm 28. A power spring piston 36 is slidably disposed in the spring portion 30 of the spring chamber 12. In an alternative embodiment of an actuator configuration, the power spring piston 36 seals to the spring chamber housing 22 and a first diaphragm is not necessary. A power spring 38 is sandwiched between the power spring piston 36 and the spring chamber housing 22. The power spring 38 exerts spring force on the power spring piston 36 causing the tubular power spring pushrod to telescope outwardly from the spring chamber 12 when the brake release portion is not pressurized.

The power spring piston 36 is interconnected to the power spring push rod 34. Therefore, the power spring 38 exerts a biasing force by way of the power spring piston 36 upon the power spring push rod 34 for providing telescoping movement to the power spring push rod 34 into the service chamber 14. The power spring 38 is compressed when the brake release portion 32 receives pneumatic pressure through pneumatic port 40 sufficient to cause the spring diaphragm 28 to translate pneumatic pressure to the power spring piston 36 causing the power spring 38 to compress.

A second flexible diaphragm 42 bifurcates the service chamber 14 into a pressure portion 15 and a return portion 17. The service chamber 14 receives pneumatic pressure from a service pneumatic port 44 to force a service push rod 46 that is connected to a service piston 47 that abuts the second flexible diaphragm 42 outwardly from the service chamber 14. The service push rod 46 actuates one of a drum brake or a disc brake (not shown) in a known manner. A piston portion 48 of the service chamber 14 is vented to the atmosphere through aperture 49 allowing air to escape when the pressure portion 15 of the service chamber 14 is subject to pneumatic pressure via the service pneumatic port 44. A service spring (not shown) disposed in the non-pressure portion 17 of the service chamber 14 biases the service pushrod 46 to retract into the service chamber 14.

FIG. 1 shows the service chamber 14 in a pressurized state causing the service push rod 46 to telescope outwardly for actuating the vehicle brake. This occurs when an operator depresses a brake pedal (not shown). FIG. 1 also shows the brake release portion 32 of the spring chamber 12 in a de-pressurized state allowing the power spring to expand causing the power spring pushrod to expand. Therefore, brake release portion 32 is de-pressurized and the pressure portion 15 of the service chamber 14 is pressurized. In this configuration, the park brake is considered actuated and the brake is fully engaged.

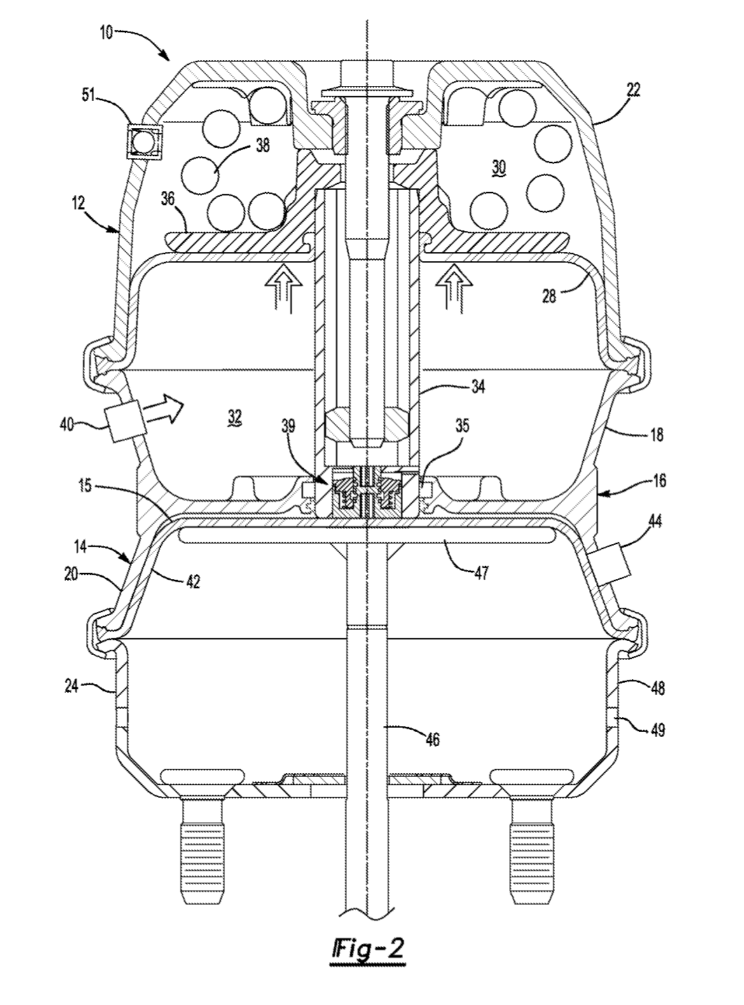

FIG. 2 shows the pressure portion 15 of the service chamber 14 being de-pressurized causing the service spring to expand retracting service push rod 46 into the service chamber 14 releasing the vehicle brake. In addition, the brake release portion 32 of the spring chamber 12 is pressurized causing the power spring 38 to be depressed and causing the power spring push rod 34 to retract into the spring chamber 12. Should the pneumatic system of the brake assembly 10 fail depressurizing the brake release portion 32 of the spring chamber 12 and the pressure portion of the service chamber 14, the power spring 38 again expands and prevents the service push rod 46 from releasing the vehicle brakes.

A check valve 51 is disposed in the spring chamber housing 22 for allowing air to be vented from the power spring portion 30 of the spring chamber housing 22 while preventing environmental contaminants from entering the spring portion 30 of the spring chamber 12. Therefore, when the check valve 51 is disposed in its closed position, the power spring portion 30 of the spring chamber 12 is completely sealed to the environment. The check valve 51 is shown in the form of a ball valve due to its simplicity and ease of function. However, any pneumatic check valve capable of sealing the spring chamber 12 will suffice.

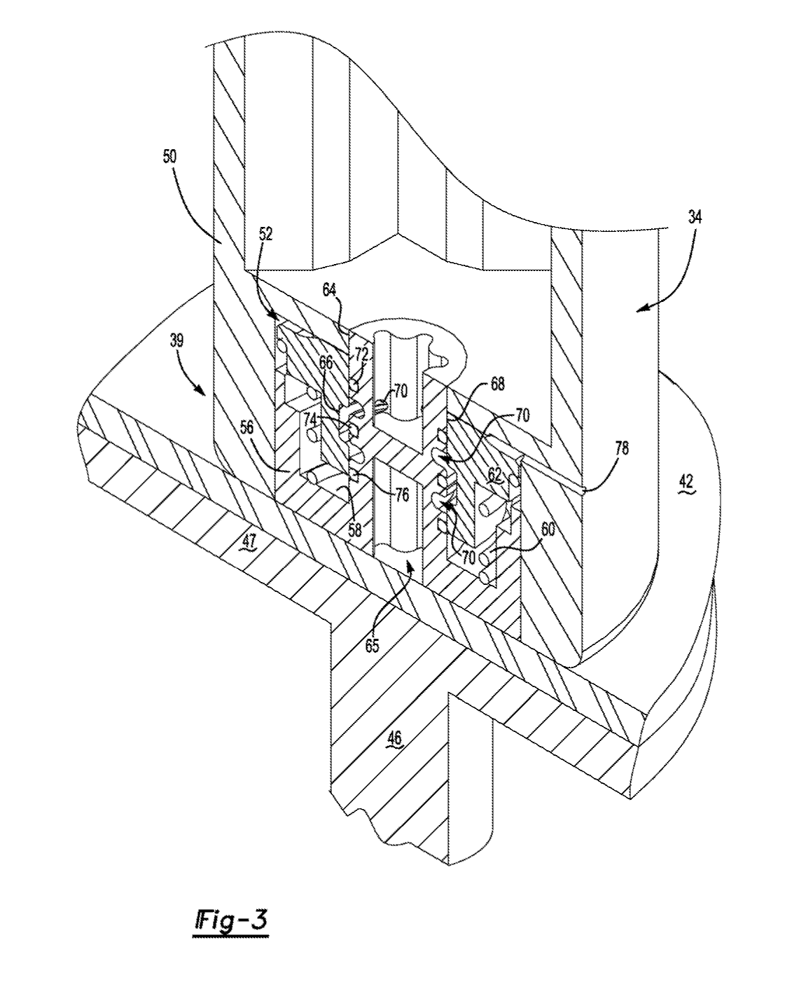

As best represented in FIGS. 3, the power spring push rod 34 is defined by a tubular wall 50 that terminates at a valve receptor 52 in a distal end 54, which is spaced from the power spring piston 36 (FIG. 2). A valve base 56 is received in the valve receptor 52 and provides a spring seat 58. A valve spring 60 is sandwiched between the spring seat 58 and a valve piston 62 for biasing the valve piston 62 in an open disposition, the purpose of which will be explained further herein below. A central portion of the spring seat 58 defines a tubular seat wall 64 that provides a throughway 65 through which air disposed in either the spring portion 30 of the spring chamber 12 or the pressure portion 15 of the service chamber 14 may pass between the two chambers 12, 14.

The valve piston 62 defines a groove 66 disposed in an inner cylindrical wall 68 that is slidably received by the seat wall 64. The seat wail 64 includes complementary openings 70 that facilitate a throughway between the power spring portion 30 of the spring chamber 12 and the pressure portion 15 of the service chamber 14 when the groove 66 defined by the inner tubular wall 68 is aligned with the openings 70. The seat wail 64 includes first, second, and third ring seals 72, 74, and 76, respectively, the purpose of which will be explained further herein below.

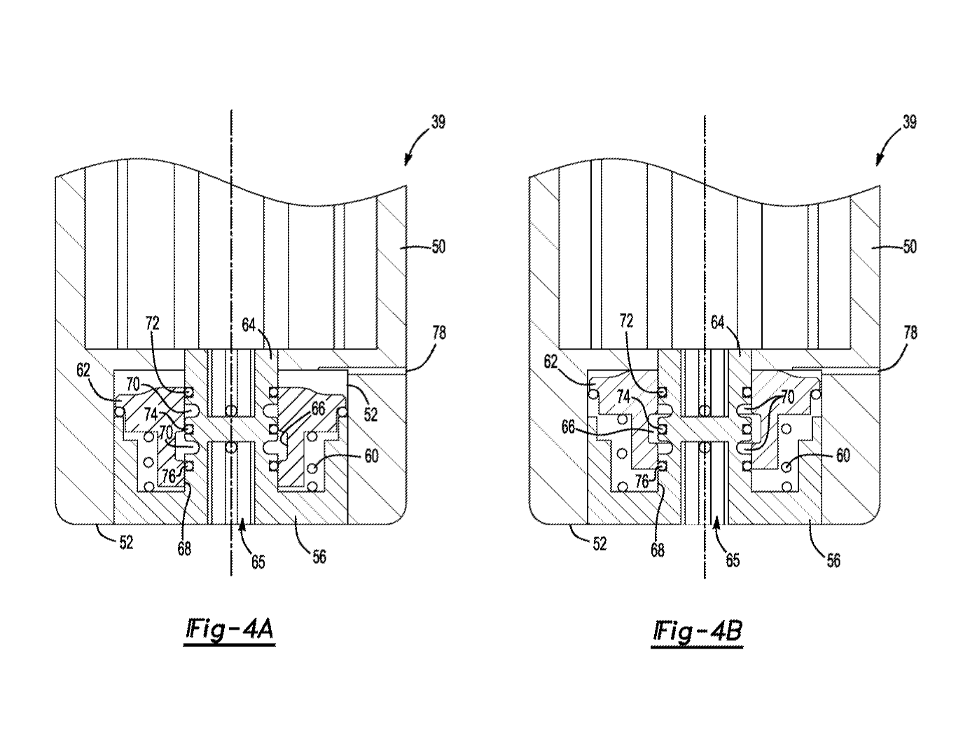

FIG. 4A shows the valve piston 62 disposed in a closed position. In the closed position, the brake release portion 32 is pressurized through pneumatic port 40 for compressing the power spring 38 as is represented in FIG. 2. Therefore, the pneumatic pressure forces the valve piston 62 to compress the valve spring 60 by way of piston port 78 defined by the valve receptor 52. When the valve piston 62 is disposed in the closed position, the third ring seal 76 and the second ring seal 74 seals to the inner tubular wall 68 of the valve piston 62. Therefore, pneumatic pressure is not transferred through the valve into the tubular wall 50 of the power spring push rod 34.

FIG. 4B shows the valve 39 in an open position when the brake release portion 32 of the spring chamber 12 is being depressurized, relieving pressure on the valve piston 62 allowing the valve piston 62 to be biased by the valve spring 60. Therefore, the groove 66 aligns with the opening 70 disengaging the second ring seal 74, enabling a transfer of pneumatic pressure through an opening 75 in the valve base 56 from the pressure portion 15 of the service chamber 14 and into the tubular wall 50 of the power spring push rod 34. Air exits the tubular wall 50 into the spring chamber 30 of the spring chamber 12. Therefore, as the power spring 38 actuates the power spring piston 36 increasing the volume of the spring portion 30 of the spring chamber 12, pressurized air from the pressure portion 15 of the service chamber 14 fills the increasing volume of the spring portion 30. While the volume of the spring portion 30 increases, the check valve 51 prevents air from outside the actuator 10 from entering the spring portion 30. When the brake release portion 32 of the spring chamber 12 is being pressurized, air is evacuated from the spring portion 30 of the spring chamber 12 through the check valve 51 to accommodate the shrinking volume of the spring portion 30.

The valve 39 of the present invention provides a durable yet simplified design for transferring air and pneumatic pressure between the spring portion 30 of the spring chamber 12 and the service chamber 14. Therefore, drawing air into the spring chamber housing 22 from outside the actuator 10 is no longer necessary and the corrosive environmental contaminants no longer impact the durability of the power spring 38.

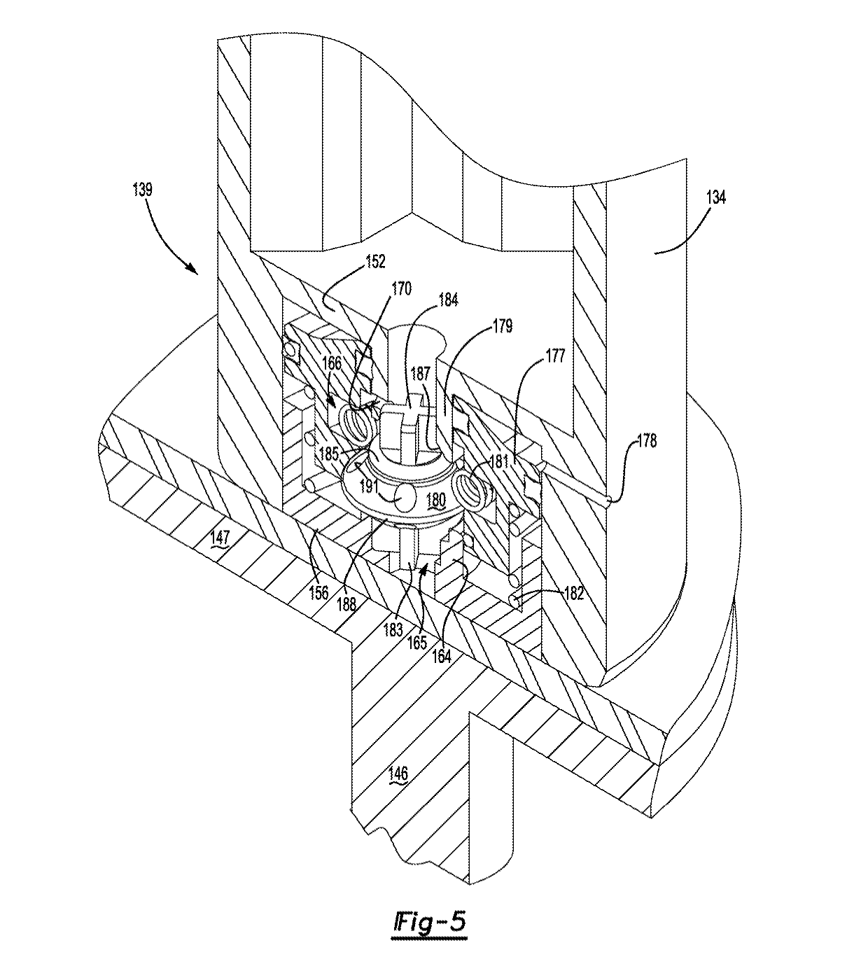

An alternative valve is shown at 139 of FIGS. 5, and 6A-6C where, other than the valve, the brake actuator 10 of the prior embodiment is identical. Therefore, like elements of the brake actuator will include like element numbers and will not be further explained herein.

The power spring pushrod 134 defines valve receptor 152 into which a valve base 156 is received. The valve base 156 defines a tubular base wall 164 that receives a valve piston 177. The tubular base wall 164 is truncated and extends toward a tubular receptor wall 179 defined by the valve receptor 152. The tubular base wall 164 defines a throughway 165 leading to the inside of the tubular pushrod 134 through the tubular receptor wall. 179. The tubular base wall 164 is spaced from the tubular receptor wall 179 so that a poppet or sealing element 180 may float there between. The poppet 180 includes opposing alignment members 183, 184, one of which is received in the tubular base wall 164 and one of which is received in the tubular receptor wall 179. Therefore, the poppet 180 remains in axial alignment along axis a with the tubular base wall. 164 and the tubular receptor wall 179 while floating there between, the purpose of which will become more evident below.

A garter spring 181 is received in a groove 166 defined in an inner cylindrical wall 186 of the piston 177. The garter spring 181 circumscribes the poppet 180. The poppet 180 includes a radial edge 188 that defines an outer diameter that is greater than an inner diameter of the garter spring. Therefore, the garter spring 181 expands in the groove 166 when the poppet 180 moves in an axial direction relative to the garter spring 181. It should be understood that the radial edge 188 of the poppet 180 is disposed either below the garter spring 181 as shown in FIG. 6A or above the garter spring 181 as shown in FIG. 6C depending on the cycle of the brake actuator 10.

When sufficient pressure is disposed in a chamber in which the alternative valve 139 is located, the valve piston 177 is forced in an opposite direction of the valve spring 182 bias. The garter spring, 181 then forces the poppet 180 into a closed position in which a poppet seal 185 to seal to an inner frustoconical wall 187 of the piston port 1178 thereby sealing the spring chamber 12 from the service chamber 14.

The valve piston 177 is biased upwardly toward the valve receptor 152 by a valve spring 182 that is disposed between the piston 177 and the valve base 156. The valve piston 177 and the poppet 180 both move relative to the other along axis a. Further, the valve piston 177 moves in the opposite direction along axis a as does the poppet 180 due to the interaction between the garter spring 181, which moves in the same direction with the piston 177, and the radial edge 188 of the poppet 1.80. The following is an explanation of the workings of the valve 39, 139. FIG. 6A shows the valve 139 in an open position. The open position is normal when neither the brake release portion 32 of the spring chamber 12 nor the pressure portion 15 of the service chamber 14 are pressurized as shown in FIG. 1. In this position air flows freely through the tubular base wall 164, through apertures 191 running through the poppet 180 and subsequently through the tubular receptor wall 179. Therefore, pressure is equalized between the brake release portion 32 of the spring chamber 12 and the pressure portion 15 of the service chamber 14. Upon release of the parking brake, air enters the brake release portion 32 compressing the power spring 38 and causing pressure to equalize between the spring chamber 30 and the pressure portion 15. When the power spring 38 is fully compressed, a piston port 178 disposed in the valve receptor 152 receive air pressure from the release chamber (now having passed through a pushrod seal 35) that force the piston 177 in a downward direction causing the garter spring 181 to reverse relative disposition to the radial edge 188 forcing the poppet 180 to move upwardly as represented in FIG. 6B. The radial edge 188 of the poppet 180 is then above the garter spring 181 and the garter spring 181 causes the poppet seal 185 of the poppet 180 to seal to the frustoconical wall 187 of the piston port 178 closing, the valve 139 as is explained above.

The following details the disposition of the valve 39, 139 and the chambers 15, 30 interconnected by the valve 39, 139 through the tubular power spring pushrod 34 during operation.

Service brake released, parking brake applied. The power spring 38 is fully extended. The pressure portion 15 of the service spring is compressed, and the valve 39, 139 is open.

Service brake remains released while the parking brake is being released. The brake release portion 32 is pressurized compressing the power spring 38, pressure is equalized between the spring chamber 12 and the service chamber 14, and the valve 39, 139 is open during transition.

Service brake remains released, parking brake remains released. When the power spring 38 is hilly compressed, the piston port 78, 178 is exposed the pressurized release portion 32 of the spring chamber 12 causing the valve 39, 139 to close.

Service brake remains released and parking brake is being applied. The brake release portion 32 of the spring chamber 12 is de-pressurized allowing the power spring 38 to expand forcing the pushrod 34, 134 into the service chamber 14. Pressure to the piston port 78, 178 is lost, opening the valve 39, 139 neutralizing pressure differential between the spring chamber 12 and the pressure portion 15 of the service chamber 14.

Service brake is being applied, parking brake remains applied. The pressure portion 15 of the service chamber 14 is pressurized while the pushrod 34, 134 remains extended causing the air pressure in the pressure portion 15 to close the valve 39, 139.

Service Brake remains applied, parking brake is being released. The pressure portion 15 of the service chamber 14 is pressurized and pressure builds in the spring release portion 32 and the spring portion 30 of the spring chamber 12. The valve 39, 139 remains closed due to the pressure differential between the spring chamber 12 and the service chamber 14 causing pressure to vent in the contracting spring portion 30 of the spring chamber 12 through the check valve 51.

Service brake is being released, parking brake remains released. Pressure is reduced in the pressure portion 15 of the service chamber 14 causing contraction of the pressure portion 15. The valve 39, 139 remains closed (the alternative valve 139 opens only momentarily as shown in FIG. 68 to neutralize pressure) while pressure differential between the spring chamber 12 and the service chamber 14 is neutralized.

Service brake is being applied, parking brake is being applied. Pressure increases in the pressure portion 15 of the service chamber 14. The valve 39, 139 remains closed.

Service brake remains applied, parking brake is being applied. The power spring pushrod 34 enters the service chamber 14 while the power spring 38 expands. Pressure in the pressure portion 15 keeps the valve 39, 139 closed creating a vacuum in the spring portion 30 of the spring chamber 12.

Service chamber is being released, parking brake remains applied. The extended power spring pushrod 34 prevents the pressure portion 15 of the service chamber 14 from contracting while depressurizing. Low pressure in the pressure portion 15 causes the valve 39, 139 to open due to the bias of the valve spring 60, 182 and releasing the vacuum.

Vehicle is inactive, service chamber remains released, parking brake remains applied. The valve 39, 139 remains open due to the valve spring 60, 182 bias.

The invention has been described in an illustrative manner, and it is to be understood that the terminology that has been used is intended to be in the nature of words of description rather than of limitation. Obviously, many modifications and variations of the present invention are possible in light of the above teachings. It is therefore to be understood that within the specification, the reference numerals are merely for convenience, and are not to be in any way limiting, and that the invention may be practiced otherwise than is specifically described. Therefore, the invention can be practiced otherwise than is specifically described within the scope of the intended claims.

What is claimed is:

1. A spring brake actuator assembly for actuating a brake, comprising:
a spring chamber and a service chamber;
a central flange defining opposing first and second cup shaped sections;
a spring chamber housing being interconnected to said first cup shaped section of said central flange case thereby defining a spring chamber and a service chamber housing being interconnected to said second cup shaped section defining a service chamber;
a reciprocating piston disposed in said spring chamber and including a tubular push rod being biased into said service chamber from said spring chamber by a power spring disposed between said spring chamber housing and said reciprocating piston;
said spring chamber being sealably bifurcated into a spring portion and a brake release portion with said brake release portion being selectively subject to pneumatic pressure for compressing said power spring disposed in said spring chamber thereby withdrawing said tubular push rod into said spring chamber;
a service diaphragm sealably defining said service chamber being subject to pneumatic pressure for driving a pushrod outwardly of said service chamber thereby actuating the brake; and
said service chamber being pneumatically connected with said spring chamber through said tubular push rod and being separable by a valve including a valve piston with said valve piston being biased within said valve to seal said service chamber from said spring chamber and said valve being open when said valve is disposed in one of said chambers that is subject to insufficient pneumatic pressure for overcoming the bias of said valve piston thereby providing pneumatic communication between said spring chamber and said service chamber.

2. The assembly set forth in claim wherein said valve includes a spring for biasing said valve piston into an open position thereby pneumatically connecting said service chamber with said spring chamber.

3. The assembly set forth in claim 1, wherein said tubular push rod includes an end portion defining a throughway between said spring chamber and said service chamber being selectively sealable by said valve.

4. The assembly set forth in claim 3, wherein said end portion defines piston port providing pneumatic communication between one of said spring chamber and said service chamber and for providing pressurized air to said valve thereby counteracting an open bias of said spring for closing said valve.

5. The assembly set forth in claim 4, wherein said valve piston is biased into an open position when pneumatic pressure in said spring chamber and said service chamber are insufficient to overcome the valve spring bias.

6. The assembly set forth in claim 1, wherein said valve piston includes an inner annular wall defining groove providing fluid communication between said spring chamber and said service chamber when said valve piston is disposed in an open position.

7. The assembly set forth in claim 6, wherein said groove is sealed when said valve piston is disposed in a closed position when subject to pneumatic pressure sufficient to counteract said bias of said valve piston.

8. The assembly set forth in claim 7, wherein said valve includes a seal element being disposed between a tubular seat wall and said valve piston for sealing said tubular seat wall to said valve piston when said valve piston is disposed in a closed position.

9. The assembly set forth in claim 11, wherein said spring chamber includes a one-way check valve for venting air disposed in said spring chamber while said brake release chamber is being pressurized.

10. The assembly set forth in claim 1, wherein said check valve provides a pneumatic seal to said power spring chamber thereby preventing environmental contaminants from entering said power spring chamber.

11. The assembly set forth in claim 1, wherein a sealing element is slidably disposed within an inner cylindrical wall of said valve piston for selectively sealing said valve.

12. The assembly set forth in claim 11, wherein said sealing element is biased in an open direction and a closed direction by a biasing element defined by a location of said valve piston.

13. The assembly set forth in claim 12, wherein said sealing element is biased in an open direction when said valve piston is biased by said valve spring and said sealing element is biased in a closed direction when pneumatic pressure overcomes the valve spring bias.

14. The assembly set forth in claim 12, wherein said sealing element comprises a poppet and said biasing element comprises a garter spring.

15. The assembly set forth in claim 1, wherein said piston chamber includes a piston diaphragm for sealing said spring portion from said brake release portion.

16. The assembly set forth in claim 1, wherein said spring piston seals said spring portion from said brake release portion.
